(19) United States
(12) Patent Application Publication
(10) Pub. No.: US 2026/0038342 A1
(43) Pub. Date: Feb. 5, 2026

(54) BONUS SYSTEM AND METHOD WITH A RANDOM NUMBER GENERATOR

(71) Applicant: Mark Hamilton Jones and Sheryle Lynn Jones Family Trust dated November 7, 2013, Gardnerville, NV (US)

(72) Inventor: Mark H. Jones, Gardnerville, NV (US)

(21) Appl. No.: 19/289,353

(22) Filed: Aug. 4, 2025

Related U.S. Application Data
(60) Provisional application No. 63/679,303, filed on Aug. 5, 2024.

(51) Int. Cl. G07F 17/32; G06F 7/58

(52) U.S. Cl. CPC G07F 17/3267; G06F 7/588; G07F 17/322; G07F 17/3239; G07F 17/3244; G07F 17/3288

(57) ABSTRACT

A bonus system for use with a roulette game or other game of chance, the bonus system including a wagering location with a plurality of numbers, wherein a player can place a bet on the plurality of numbers. An outcome determination device determines a winning number selected from the plurality of numbers. A random number generator randomly generates a bonus number from the plurality of numbers, wherein the bonus number is assigned a multiplier. When the player's bet on at least one of the plurality of numbers, the winning number, and the bonus number all match, a monetary prize for the player's bets is multiplied by the multiplier of the bonus number. The winning number and bonus number may be reported to a player tracking system.

### TECHNICAL FIELD

The present disclosure relates to a game of chance, and in particular, to the determination of an outcome for a casino game, such as roulette and other games.

### BACKGROUND

Roulette and other casino games typically involve wagering by players, with a payout being returned to the player in the event that the player's wager is successful, with the amount of the payout commensurate with the statistical odds that the outcome on which the player wagered will be the resulting outcome. In traditional roulette games, the payout for particular outcomes are predetermined and often printed on the table where players place their bets. The odds for a roulette game therefore do not change over time. Modern games have begun to introduce additional bonus wagers, outcomes, and jackpots. Bonus wagers have increased the need for protection and security for these modern games against cheating and/or collusion between a dealer and a player.

### SUMMARY OF THE DISCLOSURE

Embodiments according to the present disclosure can be applied to a variety of games of chance. In an embodiment, a bonus system, for use with a roulette game or other game of chance, includes a wagering location with a plurality of numbers, wherein a player can place a bet on the plurality of numbers. An outcome determination device for determining a winning number selected from the plurality of numbers. A random number generator is configured to randomly generate a bonus number from the plurality of numbers, wherein the bonus number is assigned a multiplier. When the player's bet matches on at least one of the plurality of numbers, the winning number, and the bonus number, a monetary prize for the player's bets is multiplied by the multiplier of the bonus number.

In an embodiment, a method of determining and communicating an outcome of a game of roulette or a game of chance includes randomly generating a bonus number from a plurality of numbers displayed at a wagering location, wherein the plurality of numbers correspond to the potential winning outcomes of the game. The method includes determining a winning number for a round of the game from a plurality of game numbers that correspond to the plurality of numbers; determining if the winning number matches the generated bonus number; and determining if a bet has been placed on the winning number at the wagering location.

In an embodiment, a method of determining and communicating an outcome of a game of roulette or a game of chance includes randomly generating, by a random number generator, a plurality of bonus numbers from a plurality of numbers displayed at a wagering location, wherein the plurality of numbers that are displayed at the wagering location correspond to the potential winning outcomes of the game. The method includes determining, by a winning number generator, a winning number for a round of the game from a plurality of game numbers that correspond to the plurality of numbers. The winning number generator (for determining the winning number of the game round) and the random number generator (for determining the bonus numbers) are not in communication with each other. The method includes determining if the winning number matches one of the plurality of bonus numbers, and determining if a bet has been placed on the winning number at the wagering location. The method may further include communicating the result of the round of the game, including the winning number, the bonus number, whether a winning wager was placed, and/or the identity of the person that placed the inner number.

The random number generators (including the separate random number generator and winning number generator) disclosed herein may be in the form of a computable readable medium and processor that can be monitored and regulated according to local customs and laws to ensure compliance and randomness within acceptable and defined parameters. The detection and monitoring of the wagers and gaming results may be performed automatically via the use of sensors or the like.

### BRIEF DESCRIPTION OF THE DRAWINGS

In the following description, details are set forth to provide an understanding of the present disclosure and are not intended to limit the scope of the present disclosure. In some instances, certain systems, structures and techniques have not been described or shown in detail in order not to obscure the disclosure.

FIG. 1 is a perspective view of an exemplary bonus system for a roulette game, according to an embodiment of the present disclosure; and

FIG. 2 is a flowchart illustrating a method of determining and communicating an outcome of a game of roulette or a game chance, according to an embodiment of the present disclosure.

### DETAILED DESCRIPTION OF THE ENABLING EMBODIMENTS

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative bases for teaching one skilled in the art to variously employ the embodiments. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical application. Various combinations and modifications of the features consistent with the teachings of this disclosure, however, could be desired for particular applications or implementations.

In general, the present disclosure relates to a bonus bet system and method for use with a roulette game or other games (e.g., card games, slot machines, sports, activities, events, occurrences), as it relates to a player placing a bonus bet on an outcome of the roulette game or the other games, or a portion thereof. The bonus bet system according to the present disclosure may be used by a roulette dealer and/or a player of the roulette game (or other game, etc.) to place an additional bet on the outcome of the roulette game as will be described in conjunction with one or more exemplary embodiments. However, the specific example embodiments disclosed are merely provided to describe the inventive concepts, features, aspects and objectives with sufficient clarity to permit those skilled in this art to understand and practice the disclosure. A system and method of a bonus bet system is disclosed in U.S. Pat. No. 11,562,620, the entirety of which is incorporated herein.

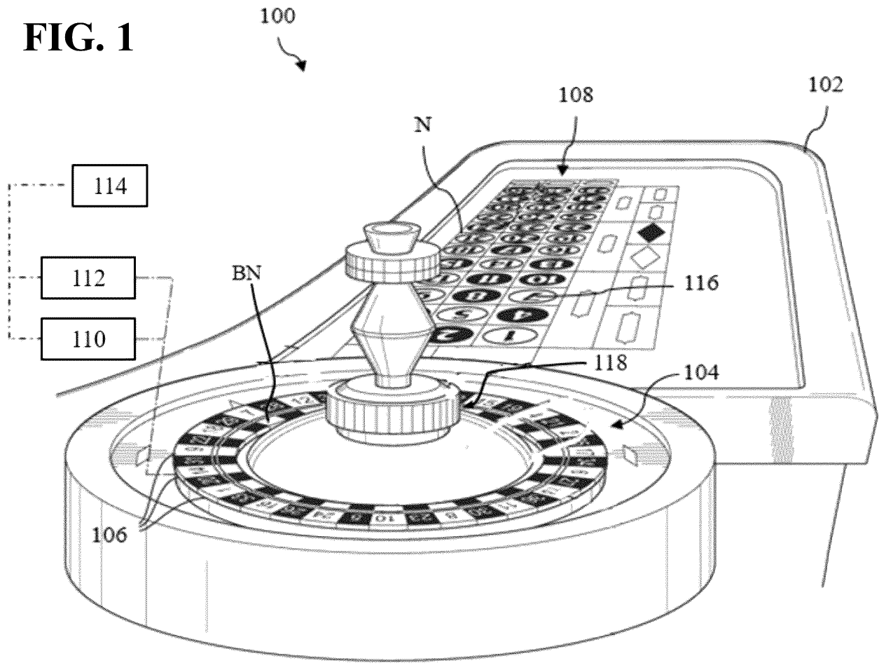

Referring to FIG. 1, in an embodiment of the present disclosure, a bonus system 100 includes a wagering location 102 with a plurality of numbers N and an outcome determination device 104. For each round, game, or the like, the outcome determination device 104 determines which of the plurality of numbers N is a winning number WN. For example, a player may place a bet by selecting one or more of the plurality of numbers N and/or an area 108 on the wagering location 102 (i.e., the player may place a bet by placing a chip on a number, a group of numbers, a color, or the like) and the player wins if the outcome determination device 104 determines the winning number WN corresponding to the one or more of the plurality of numbers N and/or an area 108 that the player bet upon. When a player's bet wins, the player may be awarded a monetary prize based on odds associated with the bet.

The wagering location 102 and/or the outcome determination device 104 may be physical objects, virtual representations, or the like or a combination or sub-combination thereof. For example, the wagering location 102 may be a physical table wherein the player places chips upon the table and the outcome determination device 104 may be virtually represented by a screen or display. In another example, the wagering location 102 may virtually represented such that the player can place a bet remotely or configured to receive remote bets by the player.

In an embodiment, the outcome determination device 104 is a roulette wheel with a plurality of roulette wheel numbers 106 that correspond to the plurality of numbers N. The outcome of the roulette wheel is determined by one of the plurality of roulette wheel numbers 106 being selected as the winning number WN. In some embodiments, the roulette wheel includes a physical roulette ball that is spun by a dealer or a machine in a track adjacent the roulette wheel and the winning number WN is determined when the roulette ball stops spinning and lands in a location or a pocket corresponding to one of the plurality of roulette wheel numbers 106. The result of a traditional physical spinning roulette wheel with a ball has been found to be randomly distributed over a statistically significant sample. In other embodiments, the roulette wheel includes a display, indicator, or other type of effect that simulates a roulette ball being spun, or simply determines an outcome, to determine one of the plurality of roulette wheel numbers 106 which may designated as the winning number WN. In some embodiments, the wagering location 102 and/or the roulette wheel are electronic displays wherein the player can place a bet remotely.

In an embodiment, the bonus system 100 includes a winning number random number generator (RNG) 110 programed and configured to randomly generating the winning number WN each round. The winning number RNG 110 may be operatively connected to and/or part of the outcome determination device 104. For example, where the outcome determination device 104 is the roulette wheel, the winning number RNG 110 may determine the winning number WN by randomly determining one of the plurality of roulette wheel numbers 106 to be the winning number WN. The determination of the one of the plurality of roulette wheel numbers 106 to be the winning number WN may not require physical movement (i.e., the roulette wheel may be animated by an illumination device to sequentially illuminate the plurality of roulette wheel numbers 106 and simulate spinning of the roulette wheel and/or the roulette ball, and which may further include a sound module or the like to simulate a traditional gaming sound, if desired). In some embodiments, the winning number RNG 110 may be programed and configured to randomly produce an outcome, wherein the outcome is one of a predetermined number of given outcomes. For example, the winning number RNG 110 may be configured to generate a number corresponding to a specific gaming outcome, or it may be configured to generate a generic sector location on the outcome determination device 104, wherein the generic sector location is highlighted or illuminated, or the like. An indicia or the like disposed at the generic sector may be accordingly identified, and the displayed indicia at the sector is the winning number WN. Put another way the RNG does not know the actual winning number that results from its output, because it is identifying a sector with a local indicia that is not a known part of the RNG output. To determine the winning number in this approach, the indicia present at the identified winning sector must be identified, for example visually or via some other sensing function.

In some embodiments, the winning number RNG 110 can be included in a computer as software (an application) or the winning number RNG 110 can be a stand-alone device including a processor and memory, or the like. A winning number RNG 110 for games of chance is disclosed in U.S. Pat. Nos. 11,861,984, 11,090,551, and U.S. Patent Application Publication No. 2022/0032169, which are incorporated herein in their entirety.

In an embodiment, the bonus system 100 includes a bonus number RNG 112 that is programed and configured to randomly generate a bonus number B. The bonus number B is based on or is a subset of the plurality of numbers N. The bonus number RNG 112 may randomly generate the bonus number BN before, during, and/or after all bets have been placed by the player(s) and betting has been called off. The bonus number BN is assigned a multiplier that multiplies the monetary prize of a winning bet. For example, if the player bets on the number 7, the bonus number RNG 112 randomly generates 7 as a bonus number BN, and the winning number WN is a 7, then player's bet is a winning bet (based on the matching wager and winning number) and the monetary prize of the winning bet is multiplied by the multiplier assigned to the bonus number BN (based on the matching winning number and bonus number). It will appreciated that a variety of gaming outcomes may occur. For instance, the winning number and bonus number may match, but there may be no matching wager. Or, the winning number and bonus number may match, but there is no match with the winning number. Or, the inning number and wager may match, but there is no bonus number. Typically, there is no prize awarded unless the winning number matches the wager, although payout rules may be modified if desired.

The multiplier may be a number within a range from 1 to 5, 10 to 100, 50 to 500, or greater than 500, or the like, or a combination or sub-combination thereof. The number of the multiplier assigned to the bonus number BN may be a variable of or dependent upon the type of roulette game. For example, a straight up bet (i.e., betting on a single number) typically has a monetary prize of 35 to 1 (i.e., the monetary prize is 35 times the amount of the bet). In a roulette game implementing the bonus system 100 of the present disclosure, the monetary prize may now payout at 30 to 1 odds and, in this way, the bonus resulting from the multiplication of the monetary prize of a winning bet is funded by the roulette game itself (i.e., the payouts of the winning bets without a multiplier are adjusted to account for the winning bets with a multiplier). Game operators may, of course, determine the specific odds for various games sufficient to fund the game in question. In this aspect, the bonus system may be described as being self-funding. The payouts for non bonus-multiplied bets being lower results in a greater “pot” to the operator, and from this pot the multiplied winnings resulting from the bonus may be provided.

In some embodiments, the bonus number RNG 112 randomly generates a plurality of bonus numbers BN that each correspond to one of the plurality of numbers N. The quantity of the plurality of plurality of bonus numbers BN randomly generated by the bonus number RNG 112 is determined by the type of roulette game or other games of chance. For example, the quantity of the plurality bonus numbers BN generated by the bonus number RNG 112 may be determined based on the total amount of the plurality of numbers N (e.g., in double zero roulette there are a total of 38 numbers), the desired funding of winning bonus bets, or the like, or a combination or sub-combination thereof. Each of the plurality of bonus numbers BN are assigned a multiplier that may be unique or shared by one or more of the plurality of bonus numbers BN. For example, in double zero roulette there may be two bonus numbers BN, such as 7 and 13, with an assigned multiplier of two and five, respectively. In this way, the odds of the winning number WN matching the bonus number BN increases (relative to a single bonus number) and may provide more entertainment and excitement to the player. In another example, there may be three, four, five, etc. bonus numbers selected from the plurality of winning numbers, with smaller multipliers, such that over time a similar amount of bonus winnings are provided, while increasing the number of times that some bonus is awarded. The number of bonus numbers generated, and the value of the multiplier, may be generated and based on the amount of funding (amount present in the pot) provided over a period of time for the game, such that when the funding exceeds a predetermined amount, the quantity of bonus numbers and/or the amount of the multiple may be increased. The number of bonus numbers and/or the value of the multipliers to be assigned may be communicated to potential players on a display board of the like to promote play. For instance, the display may indicate that for the next round of gameplay, additional bonus numbers or s specific quantity of bonus numbers will be generated, or that the multiplier of the bonus numbers is at a certain level.

In some embodiments, the bonus number BN includes a set of numbers, images, sectors, or the like, or a combination or sub-combination thereof, that are not related to the plurality of numbers N and/or the winning number WN. Prior to the random generation of the bonus number BN, the player may bet on and/or choose one of the numbers, images, sector, or the like. If the player has bet on the correct bonus number BN (i.e., the bonus number BN that is randomly generated for the round) and has bet on the winning number WN, then the player's bet will be multiplied by the multiplier assigned to the bonus number BN. For example, the randomly generated bonus number BN may be based on a deck of cards and the player has bet on the ace of spades and the number 7. If the winning number WN is 7 and the bonus number BN is the ace of spades, then the player's bet will be multiplied by the multiplier assigned to the bonus number BN.

Accordingly, the bonus numbers provided for wagering, and subsequently generated and selected as the winning bonus number, need not correspond to a subset of the numbers being wagered on for the main game. Rather, a second separate wager may be provided relative to the bonus number. The multiplier of the bonus number may be based on the amount of the wager. For instance, a bet on the bonus number that is twice as much as another bet on the bonus number may result in a multiplier that is doubled.

In an embodiment, the winning number RNG 110 and the bonus number RNG 112 do not communicate with each other. The bonus number RNG 112 randomly generates the bonus number BN based solely on the subset of the plurality of numbers N (or other set of potential bonus numbers/symbols/cards, etc.) and is not influenced by the generation of the winning number WN by the winning number RNG 110. In other words, the winning number RNG 110 and the bonus number RNG 112 are unware of the results generated by each other and operate individually. Accordingly, the bonus system 100 provides an unbiased result for bonus winning bets, standard winning bets, and losing bets. The bonus system 100 also provides increased protection and security against unlawful manipulation of the roulette game by the player, the dealer, or another bystander.

In an embodiment, the bonus system 100 includes a display board 114 for displaying the winning number WN of the round and/or the winning numbers WN from previous rounds. The display board 114 may be in communication with the winning number RNG 110, operatively connected to an image detection system configured to recognize the winning number WN (e.g., the location of the roulette ball, the highlighted sector, or the like), configured to receive an input from the dealer or another employee of a casino, or the like, or a combination or sub-combination thereof. A recognition device/system for casino games are disclosed in U.S. Pat. Nos. 11,562,620, 9,818,253, 8,777,727, and 9,757,641, which are incorporated herein in their entirety.

In some embodiments, the display board 114 also displays the bonus number BN and/or the plurality of bonus numbers BN for the round and/or from previous rounds. In some embodiments, the bonus number BN and/or the plurality of bonus numbers BN are displayed on another display separate from the display board 114. For example, the bonus number BN and/or the plurality of bonus numbers BN may be displayed on a display 118 connected to the outcome determination device 104. In some embodiments, the display board 114 may be in communication with the bonus number RNG 112, operatively connected to an image detection system configured to recognize the bonus number BN (e.g., the location of the roulette ball, the highlighted sector, or the like), configured to receive an input from the dealer or another employee of a casino, or the like, or a combination or sub-combination thereof.

In an embodiment, the display board 114 is configured to independently communicate with and/or receive the winning number WN from the winning number RNG 110 and the bonus number BN from the bonus number RNG 112. In this way both the winning number RNG 110 and the bonus number RNG 112 independently report the winning number WN and the bonus number BN to the display board 114 and/or a player tracking system.

In an embodiment, the wagering location 102 includes sensors 116 for detecting when the player has placed a chip or token on at least one of the plurality of numbers N (i.e., the sensors 116 detect when the player has placed a bet on one of the plurality of numbers N). The sensors 116 may be disposed in the center of each of the plurality of numbers N, and/or at the corners/lines of the numbers on a traditional roulette wagering table, in one example. For the purpose of the bonus bet arrangement, it may be required that a bonus bet multiplier is only provided in the case of betting on a single number (rather than a corner bet that places a bet on a group of four numbers, or a line bet that places a bet on a row or column of numbers, or a pair of numbers).

The sensors 116 may be a weight sensor, a light interruption sensor, image detection sensor, or the like, or a combination or sub-combination thereof. In some embodiments, the sensors 116 are configured to only recognize the player's bet for a specific one of the plurality of numbers N (e.g., the sensor 116 may be small enough to detect only straight up bets and not split number bets placed on the edges of markings for each of the plurality of numbers N). In some embodiments, the sensor 116 is operatively connected to a controller for determining the player's bet for a specific one of the plurality of numbers N (e.g., the controller is configured to receive an input from the one or more of the sensors 116 and determine which of the plurality of numbers N the player has placed a bet on).

In some embodiments, the wagering location 102 and/or display board 114 is configured to highlight, illuminate, or indicate the winning number WN and/or one of the plurality of numbers N of the winning bonus bet. For example, the wagering location 102 may include a lighting element underneath or targeting each of the plurality of numbers N such that if the winning number WN matches the bonus number BN, then the lighting element will highlight the one of the plurality of numbers N corresponding to the winning number WN and signify that the winning number WN is eligible for a multiplied monetary prize (i.e., a bonus payout). The indication of the lighting element may include a lighting color, intensity, pattern, or the like. Similarly, the display board 114 may be configured to indicate that the winning number WN is eligible for the multiplied monetary prize by highlighting a text of the winning number WN, the bonus number BN, displaying a graphic or animation, or the like.

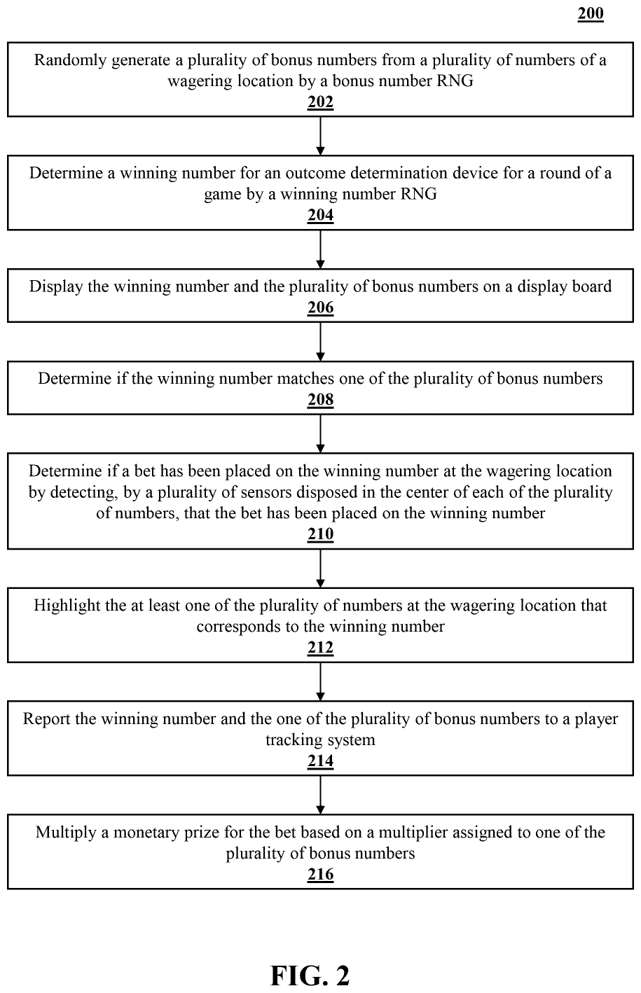

FIG. 2 illustrates a method 200 for determining and communicating an outcome of a game of chance, according to an embodiment of the present disclosure. At 202 the bonus number RNG 112 randomly generates the plurality of bonus numbers BN from the plurality of numbers N of the wagering location 102. For example, in a game of double zero roulette there are numbers 1-36, 0, and 00 and the bonus number RNG 112 may randomly generate 7 and 13 as bonus numbers BN. It will be appreciated that other subsets and/or quantities of numbers may be generated, with different bonus multipliers assigned to different bonus numbers as part of the generation of the bonus number (or symbol). The overall sample and quality of bonus to select from the sample may be predetermined, such that the random selection is performed based on this known sample. As described, the overall sample of numbers may be the same as the plurality of numbers N from the game, with the bonus numbers that are generated by the RNG 112 being selected from this sample.

At 204 the winning number WN of the outcome determination device 104 is determined by the winning number RNG 110 from the plurality of numbers N. In some embodiments, step 204 may occur before, after, or at the same time as step 202, because this determination is made independently. At 206 the plurality of bonus numbers BN and the winning number WN are displayed on the display board 114 (and/or on the gaming table). At 208 the bonus system 100 determines if the winning number WN matches one of the plurality of bonus numbers BN. At 210 the bonus system 100 determines if one of the sensors 116 has detected that the player has placed a bet on the one of the plurality of numbers N that corresponds to the winning number WN. In other words, the bonus system 100 is configured to automatically determine whether the bonus winning bet has been triggered (as well as to determine whether only some of the winning number, bonus number, and/or wager match but without all three matching such that the bonus-multiplied winning result is triggered). For example, if the winning number WN is 13, one of the plurality of bonus numbers BN is 13, and player has placed a bet on the number 13, then the bonus winning bet has been triggered. However, if only two of the three match, then the bonus winning bet is not triggered, although there may still be standard winning bet. In the case of the bonus winning bet being determined, at 212 the bonus system 100 indicates that winning number WN is eligible for being multiplied by the multiplier assigned to the bonus number BN matching the winning number WN.

In some embodiments, step 204 may further include reporting the winning number WN of the outcome determination device 104 to a player tracking system or gaming tracking system. In some embodiments, at step 204 the bonus number RNG 112 and the winning number RNG 110 independently report the bonus number BN and the winning number WN to the display board 114 and/or the player tracking system. In some embodiments, the method 200 includes step 214 wherein the winning number WN, the bonus number BN, the multiplier, and/or the player's bet are reported to the player tracking system. In this way, there is an added layer of protection against unlawful manipulation of the bonus bet system. The results of the gaming trials are stored and tracked, which can be automatically evaluated to detect potential collusion or other gaming manipulation. The separately operated RNGs, as well as the sensors for determining the wagering location, provide additional protection against collusion and the like. In some embodiments, the method 200 include step 216 multiplying a monetary prize for the bet based on a multiplier assigned to one of the plurality of bonus numbers BN.

In an embodiment, the bonus number RNG 112 and/or the winning number RNG 110 may send and receive data from the components of the bonus system 100, make determinations based on the received data, and may control the operation of the components based on the determinations and received data. In certain embodiments, the bonus number RNG 112 and/or the winning number RNG 110 includes processor hardware (shared, dedicated, or group) that executes code and memory hardware (shared, dedicated, or group) that stores code executed by the processor hardware. The code is configured to provide the features of the methods and systems described herein. To carry out the control commands provided herein, a controller may include the bonus number RNG 112 and/or the winning number RNG 110, memory, and non-volatile storage. The bonus number RNG 112 and/or the winning number RNG 110 may include one or more devices selected from microprocessors, micro-controllers, digital signal processors, microcomputers, central processing units, field programmable gate arrays, programmable logic devices, state machines, logic circuits, analog circuits, digital circuits, or any other devices that manipulate signals (analog or digital) based on computer-executable instructions residing in memory. The memory may include a single memory device or a plurality of memory devices including, but not limited to, random access memory (“RAM”), volatile memory, non-volatile memory, static random-access memory (“SRAM”), dynamic random-access memory (“DRAM”), flash memory, cache memory, or any other device capable of storing information. The non-volatile storage may include one or more persistent data storage devices such as a hard drive, optical drive, tape drive, non-volatile solid-state device, or any other device capable of persistently storing information. The bonus number RNG 112 and/or the winning number RNG 110 may be configured to read into memory and execute computer-executable instructions embodying one or more software programs residing in the non-volatile storage. Programs residing in the non-volatile storage may include or be part of an operating system or an application, and may be compiled or interpreted from computer programs created using a variety of programming languages and/or technologies, including, without limitation, and either alone or in combination, Java, C, C++, C#, Objective C, Fortran, Pascal, Java Script, Python, Perl, and PL/SQL. The computer-executable instructions of the programs may be configured, upon execution by the bonus number RNG 112 and/or the winning number RNG 110, to randomly generate the bonus numbers BN or to determine the outcome of the outcome determination device 104, respectively, for example.

Implementations of the subject matter and the operations described in this specification can be implemented in digital electronic circuitry, or in computer software embodied on a tangible medium, firmware, or hardware, including the structures disclosed in this specification and their structural equivalents, or in combinations of one or more of them. Implementations of the subject matter described in this specification can be implemented as one or more computer programs embodied on a tangible medium, e.g., one or more modules of computer program instructions, encoded on one or more computer storage media for execution by, or to control the operation of, a data processing apparatus. A computer storage medium can be, or be included in, a computer-readable storage device, a computer-readable storage substrate, a random or serial access memory array or device, or a combination of one or more of them. The computer storage medium can also be, or be included in, one or more separate components or media (e.g., multiple CDs, disks, or other storage devices). The computer storage medium may be tangible and non-transitory.

A computer program (also known as a program, software, software application, script, or code) can be written in any form of programming language, including compiled languages, interpreted languages, declarative languages, and procedural languages, and the computer program can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, libraries, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., a field programmable gate array (“FPGA”) or an application specific integrated circuit (“ASIC”).

Obviously, many modifications and variations of the present invention are possible in light of the above teachings and may be practiced otherwise than as specifically described while within the scope of the appended claims. These antecedent recitations should be interpreted to cover any combination in which the inventive novelty exercises its utility. The use of the word “said” in the apparatus claims refers to an antecedent that is a positive recitation meant to be included in the coverage of the claims whereas the word “the” precedes a word not meant to be included in the coverage of the claims.

It should be understood that an aspect of the bonus system 100 and method 200 as disclosed herein may be applied to other casino-style games, such as card games, slot machines, video poker, or bingo. Additionally and alternatively, an aspect may be applied to other non-casino games, such as before sporting events (e.g., football, baseball), or before events within sporting events (e.g., whether a team scores a certain number of points, the performance of a particular player).

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated degrees or at other orientations) and the spatially relative descriptions used herein interpreted accordingly.

What is claimed is:

1. A bonus system for use with a roulette game or other game of chance, the bonus system comprising:
a wagering location with a plurality of numbers, wherein a bet is placed on at least one of the plurality of numbers;
an outcome determination device that determines a winning number selected from the plurality of numbers;
a random number generator that randomly generates a bonus number from the plurality of numbers, wherein the bonus number that is generated includes a multiplier; and
wherein when the bet on at least one of the plurality of numbers, the winning number, and the bonus number all match, a monetary prize for the bet is multiplied by the multiplier of the bonus number.

2. The bonus system of claim 1 wherein the random number generator is configured to randomly generate a plurality of bonus numbers from the plurality of numbers, and wherein the each of the plurality of bonus number is assigned a multiplier.

3. The bonus system of claim 2 wherein a quantity of the plurality of bonus numbers is determined by a total quantity of the plurality of numbers or by funding of the monetary prize being multiplied by the multiplier.

4. The bonus system of claim 1 wherein the multiplier is a number within a range from 1 to 100.

5. The bonus system of claim 1 further comprising:
a winning number generator operatively connected to the outcome determination device for randomly generating the winning number;
wherein the winning number generator and the random number generator are not in communication with each other such that the bonus number randomly generated by the random number generator is unknown to the winning number generator and vice versa.

6. The bonus system of claim 5, further comprising a display board, wherein the display board displays the bonus number determined by the random number generator and the bonus number is highlighted when the bonus number matches the winning number.

7. The bonus system of claim 1 further comprising:
sensors disposed at each of the plurality of numbers that detect when the player has placed the bet on at least one of the plurality of numbers.

8. The bonus system of claim 7 wherein the wagering location is configured to highlight the at least one of the plurality of numbers corresponding to the winning number when at least one of the sensors detects the bet has been placed on the winning number.

9. The bonus system of claim 1 wherein the outcome determination device is a roulette wheel with a plurality of roulette wheel numbers that correspond to the plurality of numbers.

10. A method of determining and communicating an outcome of a game of roulette or a game of chance, the method comprising:
randomly generating a bonus number from a plurality of numbers displayed at a wagering location, wherein the plurality of numbers corresponding to a potential winning outcomes of the game;
determining a winning number for a round of the game from a plurality of game numbers that correspond to the plurality of numbers;
determining that the winning number matches the generated bonus number; and
determining that a bet is placed on the winning number at the wagering location.

11. The method of claim 10 wherein the step of determining that the bet is placed on the winning number includes detecting, by at least one of a plurality of sensors disposed at each of the plurality of numbers, that the bet is placed on the winning number.

12. The method of claim 11 further comprising:
highlighting the winning number and the bonus at the wagering location.

13. The method of claim 10 further comprising:
reporting the winning number and the bonus number to a player tracking system.

14. The method of claim 10 wherein the step of randomly generating the bonus number includes determining the bonus number with a random number generator, and the step of determining the winning number includes determining the winning number with a winning number generator;
wherein the winning number generator and the random number generator are not in communication with each other.

15. The method of claim 10 further comprising displaying the winning number and the bonus number on a display.

16. The method of claim 10 further comprising multiplying a monetary prize for the bet based on a multiplier assigned to the determined bonus number when the bet is placed on the winning number, and the winning number corresponds to the determined bonus number.

17. A method of determining and communicating an outcome of a game of roulette or a game of chance, the method comprising:
providing a wagering location for a game of chance, wherein the wagering location includes a plurality of numbers corresponding to a potential winning outcomes of the game
randomly generating, by a random number generator, at least one bonus number or symbol, wherein the at least one bonus number or symbol is selected from a predetermined set of potential bonus numbers or symbols;
determining, by a winning number generator, a winning number for a round of the game of chance from the plurality of potential winning numbers;
wherein the winning number generator and the random number generator are not in communication with each other;
determining that the winning number matches one of the at least one bonus number or symbol; and
determining that a player bet placed on the winning number at the wagering location;
providing a payout based on the winning number, bonus number, and player bet.

18. The method of claim 10 further comprising:
reporting the winning number and the at least one bonus number to a player tracking system.

19. The method of claim 10 further comprising displaying the winning number and the at least one bonus number on a display.

20. The method of claim 10 further comprising multiplying a monetary prize for the payout based on a multiplier assigned to the bonus number that matches the winning number.
